(19) United States
(12) Patent Application Publication
(10) Pub. No.: US 2022/0315079 A1
(43) Pub. Date: Oct. 6, 2022

(54) APPARATUS AND SYSTEMS FOR TRANSPORT OF CONSUMER PRODUCTS

(71) Applicant: Elements Group LLC, Mesquite, TX (US)

(72) Inventor: JOSH MICKLOS, Mesquite, TX (US)

(73) Assignee: Elements Group LLC, Mesquite, TX (US)

(21) Appl. No.: 17/709,256

(22) Filed: Mar. 30, 2022

Related U.S. Application Data
(60) Provisional application No. 63/168,100, filed on Mar. 30, 2021.

(51) Int. Cl. B62B 1/14; B62B 1/26

(52) U.S. Cl. CPC B62B 1/14; B62B 1/264; B62B 2202/02; B62B 2301/254; B62B 2203/44

(57) ABSTRACT

An apparatus for transporting packages is comprised of a horizontal member; a right roller mount proximate the corner of the back surface and the right surface of the horizontal member; a left roller mount proximate the corner of the back surface and the left surface of the horizontal member; a roller rotatably coupled to the right and left roller mounts; and a substantially vertical member. A system is comprised of the apparatus and a package secured to the top surface of the horizontal member. A consumer article may be positioned in the package. Methods of use of the systems for transport of consumer articles is also described herein. The apparatus, systems, and methods may permit convenient reuse of the apparatus and package.

### FIELD OF THE INVENTION

Generally, the present disclosure relates to an apparatus and system for the transport of consumer products; specifically, for transport of individual units of the consumer products to end-users.

### DESCRIPTION OF THE RELATED ART

Foam body support structures, such as mattresses, have provided desirably high levels of firmness and support for many users. However, these mattresses tend to be large, bulky, and heavy. Hence moving the mattresses can be a difficult and cumbersome affair, normally requiring two or more individuals of substantial strength.

The present disclosure may address and/or at least reduce one or more of the problems identified above.

### SUMMARY OF THE INVENTION

The following presents a simplified summary of the disclosure in order to provide a basic understanding of some aspects of the disclosure. This summary is not an exhaustive overview of the disclosure. It is not intended to identify key or critical elements of the disclosure or to delineate the scope of the disclosure. Its sole purpose is to present some concepts in a simplified form as a prelude to the more detailed description that is discussed later.

In one embodiment, the present disclosure is directed to an apparatus, comprising a substantially horizontal member comprising a top surface, a front surface, a back surface, a right surface, and a left surface, wherein the front surface and the back surface are at opposite ends of the horizontal member, the right surface and the left surface are at the other opposite ends of the horizontal member, each pair of adjacent surfaces defines a corner, and the top surface substantially defines a horizontal plane; a right roller mount proximate the corner of the back surface and the right surface of the horizontal member; a left roller mount proximate the corner of the back surface and the left surface of the horizontal member; a roller having a right end rotatably coupled to the right roller mount and a left end rotatably coupled to the left roller mount, wherein, when the horizontal member is positioned on a substantially horizontal surface, the roller does not contact the substantially horizontal surface, and when the front surface of the horizontal member is sufficiently elevated above the substantially horizontal surface, the roller contacts the substantially horizontal surface; and a substantially vertical member comprising a front surface, a back surface, a bottom, a right surface, a left surface, and a top surface, wherein the bottom is integrated with or affixed to the horizontal member in proximity to the right roller mount and the left roller mount, and the front surface substantially defines a vertical plane.

In one embodiment, the present disclosure is directed to a system, comprising (a) an apparatus, comprising (i) a substantially horizontal member comprising a top surface, a front surface, a back surface, a right surface, and a left surface, wherein the front surface and the back surface are at opposite ends of the horizontal member, the right surface and the left surface are at the other opposite ends of the horizontal member, each pair of adjacent surfaces defines a corner, and the top surface substantially defines a horizontal plane; (ii) a right roller mount proximate the corner of the back surface and the right surface of the horizontal member; (iii) a left roller mount proximate the corner of the back surface and the left surface of the horizontal member; (iv) a roller having a right end rotatably coupled to the right roller mount and a left end rotatably coupled to the left roller mount, wherein, when the horizontal member is positioned on a substantially horizontal surface, the roller does not contact the substantially horizontal surface, and when the front surface of the horizontal member is sufficiently elevated above the substantially horizontal surface, the roller contacts the substantially horizontal surface; (v) a substantially vertical member comprising a front surface, a back surface, a bottom, a right surface, a left surface, and a top surface, wherein the bottom is integrated with or affixed to the horizontal member in proximity to the right roller mount and the left roller mount, and the front surface substantially defines a vertical plane; (vi) an upper strap mounted to the front surface of the vertical member closer to the top surface than to the bottom surface and comprising an upper fastener, wherein the upper strap provides a circle of about a first circumference when the upper fastener is fastened; and (vii) a lower strap mounted to the front surface of the vertical member closer to the bottom surface than to the top surface and comprising a lower fastener, wherein the lower strap provides a circle of about the first circumference when the lower fastener is fastened; and (b) a cylindrical package having a circumference about the first circumference and a height greater than the distance between the top surface of the horizontal member and the upper strap.

In one embodiment, the present disclosure is directed to a method, comprising positioning a consumer article selected from mattresses, pillows, sheets, blankets, or comforters inside a cylindrical package having a first circumference and a first height; receiving a user request to transport the consumer article; securing the cylindrical package into an apparatus comprising (i) a substantially horizontal member comprising a top surface, a front surface, a back surface, a right surface, and a left surface, wherein the front surface and the back surface are at opposite ends of the horizontal member, the right surface and the left surface are at the other opposite ends of the horizontal member, each pair of adjacent surfaces defines a corner, and the top surface substantially defines a horizontal plane; (ii) a right roller mount proximate the corner of the back surface and the right surface of the horizontal member; (iii) a left roller mount proximate the corner of the back surface and the left surface of the horizontal member; (iv) a roller having a right end rotatably coupled to the right roller mount and a left end rotatably coupled to the left roller mount; (v) a substantially vertical member comprising a front surface, a back surface, a bottom, a right surface, a left surface, and a top surface, wherein the bottom is integrated with or affixed to the horizontal member in proximity to the right roller mount and the left roller mount, and the front surface substantially defines a vertical plane; (vi) an upper strap mounted to the front surface of the vertical member closer to the top surface than to the bottom surface and at a distance from the horizontal member that is less than the first height, and comprising an upper fastener; and (vii) a lower strap mounted to the front surface of the vertical member closer to the bottom surface than to the top surface and comprising a lower fastener; wherein, during the securing, the horizontal member is positioned on a substantially horizontal surface such that the roller does not contact the substantially horizontal surface, and, after the securing, the upper strap provides a circle of about the first circumference when the upper fastener is fastened and the lower strap provides a circle of about the first circumference when the lower fastener is fastened; elevating the front surface of the horizontal member sufficiently above the substantially horizontal surface such that the roller contacts the substantially horizontal surface; and transporting the consumer article at least in part by rolling the roller along the substantially horizontal surface.

### BRIEF DESCRIPTION OF THE DRAWINGS

The disclosure may be understood by reference to the following description taken in conjunction with the accompanying drawings, in which like reference numerals identify like elements, and in which:

FIG. 1A presents a right side view of an apparatus, in accordance with embodiments herein.

FIG. 1B presents a rear view of the apparatus, in accordance with embodiments herein.

FIG. 1C presents a top view of the apparatus, in accordance with embodiments herein.

FIG. 2A presents a right side view of a system, in accordance with embodiments herein.

FIG. 2B presents a rear view of the system, in accordance with embodiments herein.

FIG. 2C presents a top view of the system, in accordance with embodiments herein.

FIG. 3A is a flowchart of a first method, in accordance with embodiments herein.

FIG. 3B is a flowchart of a second method, in accordance with embodiments herein.

FIG. 4A is a perspective view of an apparatus, in accordance with embodiments herein.

FIG. 4B is a perspective view of a system, in accordance with embodiments herein.

FIG. 4C is a perspective view of an alternative implementation of a system, in accordance with embodiments herein.

FIG. 5A is a perspective view of the system of FIG. 4B in a mobile conformation, in accordance with embodiments herein.

FIG. 5B is a perspective view of the system of FIG. 4B in an immobile conformation, in accordance with embodiments herein.

FIG. 5C is a perspective view of an apparatus, in accordance with embodiments herein.

FIG. 5D is a perspective view of a cylindrical package, in accordance with embodiments herein.

FIG. 5E is a perspective view of a consumer article which may be packaged in the cylindrical package, in accordance with embodiments herein.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

### DETAILED DESCRIPTION

Various illustrative embodiments of the disclosure are described below. In the interest of clarity, not all features of an actual implementation are described in this specification. It will, of course, be appreciated that, in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

The present subject matter will now be described with reference to the attached figures. Various structures, systems and devices are conceptually depicted in the drawings for purposes of explanation only and to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

In one embodiment, the present disclosure relates to an apparatus, comprising apparatus, comprising a substantially horizontal member comprising a top surface, a front surface, a back surface, a right surface, and a left surface, wherein the front surface and the back surface are at opposite ends of the horizontal member, the right surface and the left surface are at the other opposite ends of the horizontal member, each pair of adjacent surfaces defines a corner, and the top surface substantially defines a horizontal plane; a right roller mount proximate the corner of the back surface and the right surface of the horizontal member; a left roller mount proximate the corner of the back surface and the left surface of the horizontal member; a roller having a right end rotatably coupled to the right roller mount and a left end rotatably coupled to the left roller mount, wherein, when the horizontal member is positioned on a substantially horizontal surface, the roller does not contact the substantially horizontal surface, and when the front surface of the horizontal member is sufficiently elevated above the substantially horizontal surface, the roller contacts the substantially horizontal surface; and a substantially vertical member comprising a front surface, a back surface, a bottom, a right surface, a left surface, and a top surface, wherein the bottom is integrated with or affixed to the horizontal member in proximity to the right roller mount and the left roller mount, and the front surface substantially defines a vertical plane.

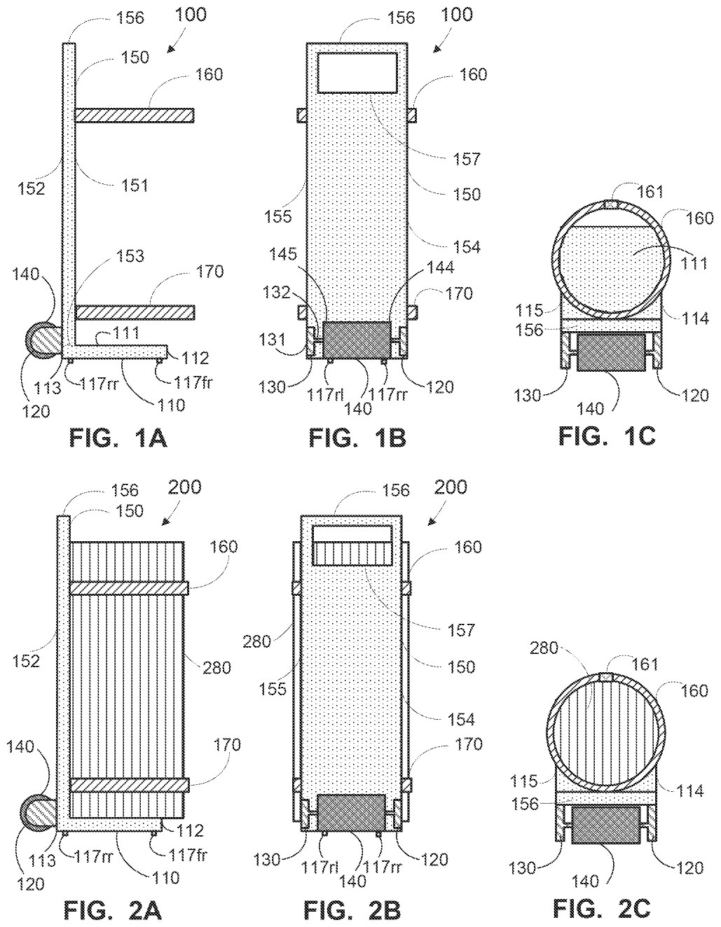

FIG. 1A-FIG. 1C show various views of an apparatus 100. Specifically, FIG. 1A presents a right side view, FIG. 1B presents a rear view, and FIG. 1C presents a top view of the apparatus 100.

The apparatus 100 comprises a substantially horizontal member 110. By “substantially horizontal” is meant that the top surface 111 substantially defines a horizontal plane. In addition to the top surface 111, the substantially horizontal member 110 also comprises a front surface 112, a back surface 113, a right surface 114, and a left surface 115. As best shown in FIG. 1A, the front surface 112 and the back surface 113 are at opposite ends of the horizontal member 110. As best shown in FIG. 1C, the right surface 114 and the left surface 115 are at the other opposite ends of the horizontal member 110. As should be apparent, each pair of adjacent surfaces defines a corner.

The apparatus 100 also comprises a right roller mount 120. The right roller mount 120 is positioned proximate the corner of the back surface 113 and the right surface 114 of the horizontal member 110. Similarly, the apparatus 100 also comprises a left roller mount 130. The left roller mount 130 is positioned proximate the corner of the back surface 113 and the left surface 115 of the horizontal member 110.

The apparatus 100 additionally comprises a roller 140 having a right end 144 rotatably coupled to the right roller mount 120, and a left end 145 rotatably coupled to the left roller mount 130. For example, as depicted, the roller mounts 120, 130 may comprise a flange (e.g., flange 131 of left roller mount 130) and a spindle (e.g., spindle 132 of left roller mount 130). The roller 140 may have a radius greater than the distance from the spindle 132 to the semicircular surface of flange 131.

The apparatus 100 also comprises a substantially vertical member 150. By “substantially vertical” is meant that the front surface 151 substantially defines a vertical plane. The substantially vertical member 150 comprises a front surface 151, a back surface 152, a bottom 153, a right surface 154, a left surface 155, and a top surface 156. In the depicted embodiment, the bottom 153 is integrated with the horizontal member 110 in proximity to the right roller mount 120 and the left roller mount 130. In other embodiments, not shown, the bottom 153 may be affixed to the horizontal member 110 in proximity to the right roller mount 120 and the left roller mount 130. The affixment may be essentially permanent (e.g., may comprise glue or other adhesive, one or more rivets, one or more nails, or the like), or may be reversible (e.g., may comprise one or more screws or bolts with corresponding holes into and/or through the vertical member 150 and the horizontal member 110).

In embodiments, the horizontal plane of the horizontal member 110 and the vertical plane of the vertical member 150 are substantially orthogonal, i.e., their intersection defines a 90° angle. In other embodiments, the horizontal plane of the horizontal member 110 and the vertical plane of the vertical member 150 are not orthogonal, differing by as much as about 10 degrees.

The apparatus 100 and its components may be formed from any appropriate materials, e.g., plastic, metal, wood, wood products (e.g., plywood, particle board, or fiber board, optionally overlaid with a veneer, etc.)

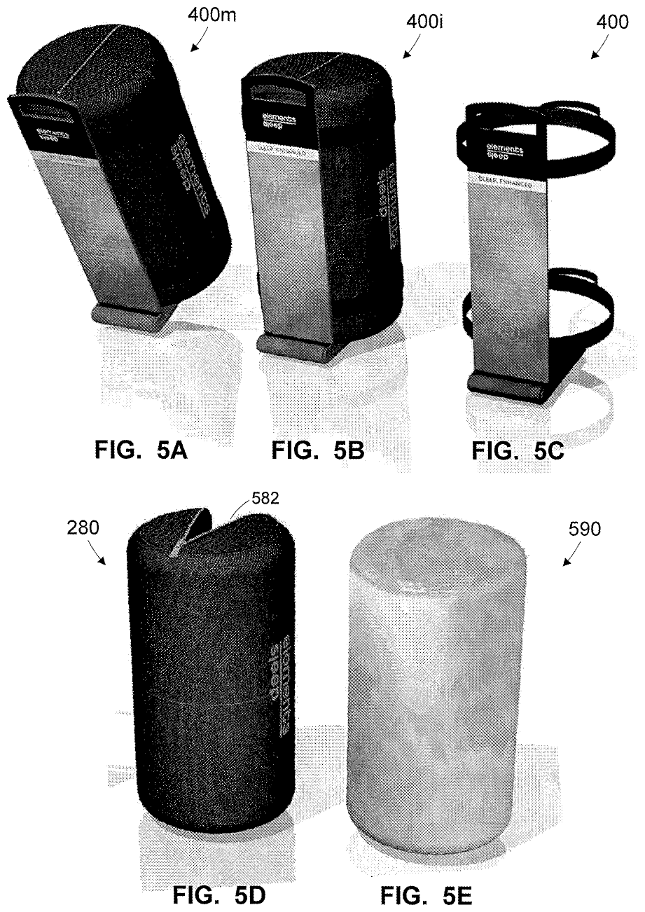

The apparatus 100 is configured such that, when the horizontal member 110 is positioned on a substantially horizontal surface, such as a floor surface, the roller 140 does not contact the substantially horizontal surface or at least does not support the substantially horizontal member 110. In one embodiment, this configuration may be affected by the presence of feet, collectively 117, with specific feet 117rr, 117fr, and 117rl depicted. In another embodiment, not shown in FIG. 1A-FIG. 1C, the roller mounts 120 and 130, and with them, the roller 140, may be positioned high enough on the substantially vertical member 150 described below that the bottom of the horizontal member 110 need not have feet 117 for the roller 140 to not contact the substantially horizontal surface. When the apparatus 100 is in the above configuration, the apparatus 100 is substantially unable to be moved by rolling the roller 140 over the substantially horizontal surface. FIG. 5B shows a system 400 in accordance with embodiments herein, wherein the system is in a substantially immobile position 400i.

The apparatus 100 is further configured that, when the front surface 112 of the horizontal member 110 is sufficiently elevated above the substantially horizontal surface such as by tilting the apparatus 100, the roller 140 contacts the substantially horizontal surface. When the apparatus 100 is in the above configuration, the apparatus 100 may be moved by rolling the roller 140 over the substantially horizontal surface. FIG. 5A shows the system 400 in accordance with embodiments herein, wherein the system is in a mobile position 400m.

As shown in the depicted embodiment of FIG. 1A-FIG. 1C, the apparatus 100 may further comprise an upper strap 160 mounted to the front surface 151 of the vertical member 150 closer to the top surface 156 than to the bottom surface 153, and/or a lower strap 170 mounted to the front surface 151 of the vertical member 150 closer to the bottom surface 153 than to the top surface 156. Although both an upper strap 160 and a lower strap 170 are shown in FIG. 1A-FIG. 1C, this embodiment is exemplary and not limiting. The apparatus 100 may comprise one strap, three straps, four straps, or more.

Each strap 160, 170 may be formed from a pliable material, e.g., a fabric, or from a material that conforms its shape, e.g., a rigid or semi-rigid plastic.

As represented in FIG. 1C, the upper strap 160 and the lower strap 170 may each further comprise a fastener, e.g. upper fastener 161 of upper strap 160. Each fastener may independently be selected from a buckle, a snap, a button, paired magnets, complementary hook-and-loop fabric, a cinch, or a ratchet.

As depicted in FIG. 1A-FIG. 1C, the upper strap 160 and the lower strap 170 may be each configured to provide a circle of substantially the same circumference when the fasteners (e.g., upper fastener 161 is closed.

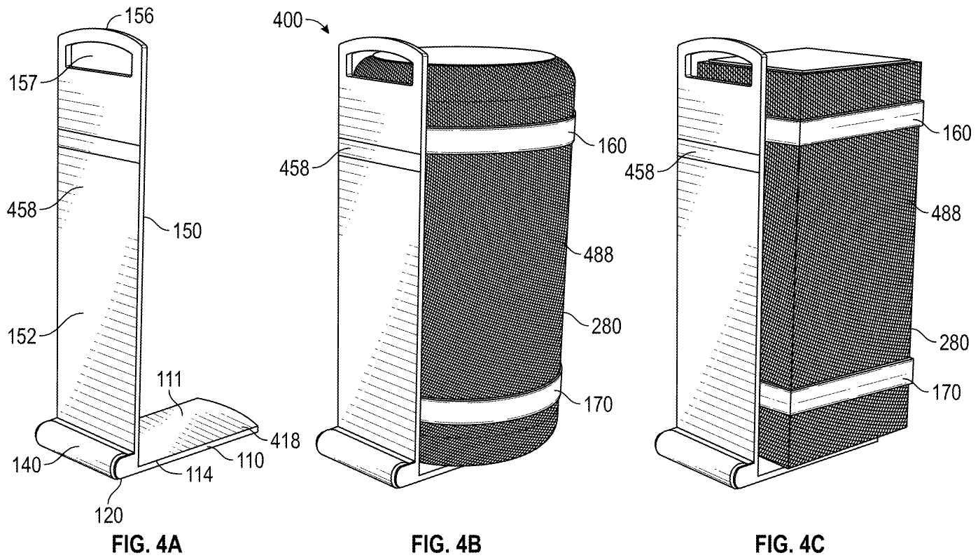

In the embodiment depicted in FIG. 1B, the vertical member 150 further comprises an opening, which may take the form of a cutout 157 in proximity to the top surface 156, wherein the cutout 157 is sufficiently large to receive a 95th percentile male hand. The cutout 157 may be used as a handle for movement of the apparatus 100. The shape of the cutout 157 may be varied as a routine matter, as will be shown and discussed below with reference to FIG. 4A, FIG. 4B, FIG. 4C, FIG. 5A, FIG. 5B, and FIG. 5C.

In one embodiment, the vertical member 150 may comprise a collapsible or retractable portion, similar to the collapsible or retractable handles common to wheeled luggage pieces. Though not shown, including a collapsible or retractable portion in the vertical member 150 is a routine matter for the person of ordinary skill in the art having the benefit of the present disclosure.

In another embodiment, the present disclosure relates to a system, comprising (a) an apparatus, comprising (i) a substantially horizontal member comprising a top surface, a front surface, a back surface, a right surface, and a left surface, wherein the front surface and the back surface are at opposite ends of the horizontal member, the right surface and the left surface are at the other opposite ends of the horizontal member, each pair of adjacent surfaces are joined together in various shapes that define a corner, and the top surface substantially defines a horizontal plane; (ii) a right roller mount proximate the corner of the back surface and the right surface of the horizontal member; (iii) a left roller mount proximate the corner of the back surface and the left surface of the horizontal member; (iv) a roller having a right end rotatably coupled to the right roller mount and a left end rotatably coupled to the left roller mount, wherein, when the horizontal member is positioned on a substantially horizontal surface, the roller does not contact the substantially horizontal surface, and when the front surface of the horizontal member is sufficiently elevated above the substantially horizontal surface, the roller contacts the substantially horizontal surface; (v) a substantially vertical member comprising a front surface, a back surface, a bottom, a right surface, a left surface, and a top surface, wherein the bottom is integrated with or affixed to the horizontal member in proximity to the right roller mount and the left roller mount, and the front surface substantially defines a vertical plane; (vi) an upper strap mounted to the front surface of the vertical member closer to the top surface than to the bottom surface and comprising an upper fastener, wherein the upper strap provides a circle of about a first circumference when the upper fastener is fastened; and (vii) a lower strap mounted to the front surface of the vertical member closer to the bottom surface than to the top surface and comprising a lower fastener, wherein the lower strap provides a circle of about the first circumference when the lower fastener is fastened; and (b) a cylindrical package having a circumference about the first circumference and a height greater than the distance between the top surface of the horizontal member and the upper strap. Those skilled in the art will readily appreciate that the shape of the package 280 may vary substantially, such as a package having a substantially rectangular cross section, as shown in FIG. 4C.

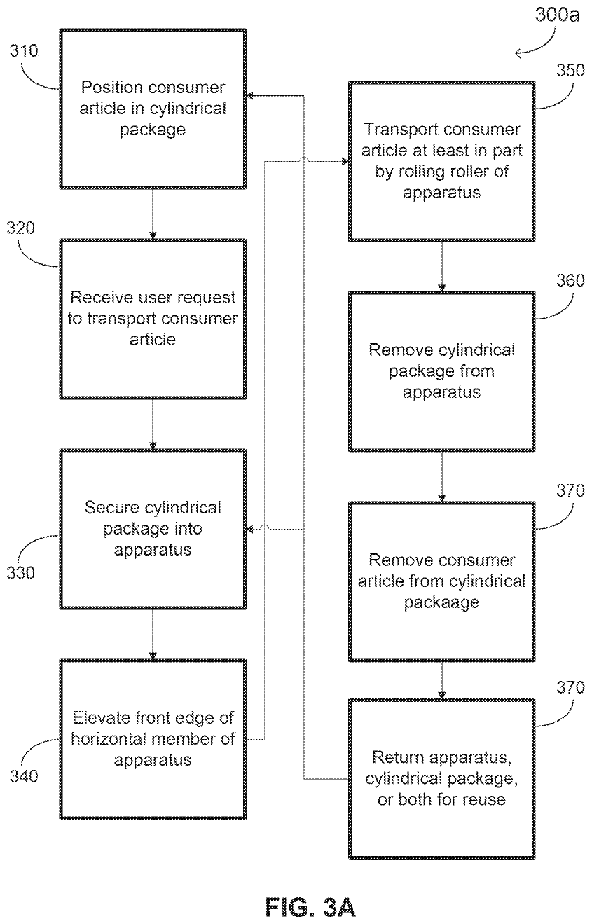

FIG. 2A-FIG. 2C show a system 200 in more detail. Particularly, FIG. 2A presents a right side view, FIG. 2B presents a rear view, and FIG. 2C presents a top view of the system 200.

The system 200 comprises an apparatus 100. The apparatus 100 is as described above.

The system 200 also comprises a package 280, which in this embodiment is cylindrical. The cylindrical package 280 has a circumference of about the inner circumference of the upper strap 160 and the lower strap 170 after fastening the fasteners of the straps. The cylindrical package 280 also has a height greater than the distance between the top surface 111 of the horizontal member 110 and the upper strap 160. Accordingly, when the cylindrical package 280 is positioned on the top surface 111, the top of the cylindrical package 280 is above the upper strap 160, and both the upper strap 160 and the lower strap 170 may securely restrain cylindrical package 280.

The height of the cylindrical package 280 may be varied as a routine matter. In one embodiment, as shown in FIG. 2B, the top of the cylindrical package 280 may be above the bottom of the cutout 157 when the cylindrical package is positioned on the top surface 111.

The cylindrical package 280 may be formed of any appropriate material. In one embodiment, the cylindrical package 280 is formed from a fabric or pliable plastic.

FIG. 4A, FIG. 4B, FIG. 4C, FIG. 5A, FIG. 5B, FIG. 5C, FIG. 5D, and FIG. 5E provide perspective views of various components of an exemplary system 400. FIG. 4A shows that the horizontal member 110 may comprise more than six faces, e.g. the edge between the top surface 111 and the 114 may comprise an ease 418. The cutout 157 may have a segmental arch shape or a three-centered arch shape, among others. The back surface 152 may comprise one or more advertising, branding, or decorative elements 458. The cylindrical package 280 may also comprise one or more advertising, branding, or decorative elements 488.

In any system 100, 400, the cylindrical package 280 may comprise a reversible closure selected from a zipper, one or more clasps, one or more snaps, one or more paired magnets, one or more cinches, one or more ratchets, or one or more pairs of hook-and-loop fabrics. FIG. 5D shows a cylindrical package 280 comprising a zipper 582.

Further, any system 100, 400 may comprise a consumer article 590 conformed to fit and be positioned inside the cylindrical package 280. In one embodiment, the consumer article 590 may be a mattress, a pillow, a sheet, a blanket, or a comforter.

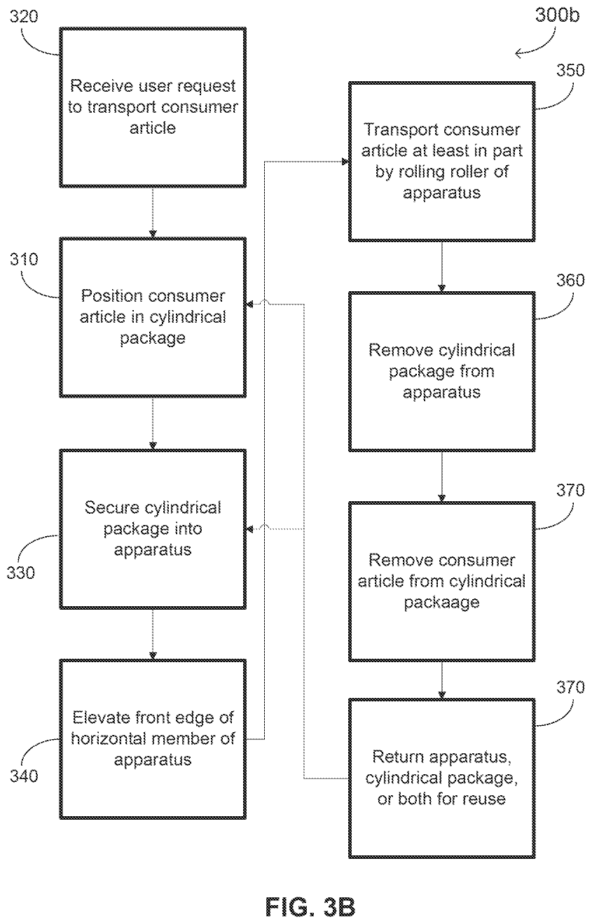

Turning now to FIG. 3A and FIG. 3B, flowcharts are presented of a first method 300a and a second method 300b in accordance with embodiments herein. The first and second methods 300a and 300b have numerous elements in common and will be generally referred to as method 300 except when discussing specific differences therebetween.

The method 300a comprises positioning (at 310) a consumer article, e.g. a consumer article selected from mattresses, pillows, sheets, blankets, or comforters inside, a cylindrical package having a first circumference and a first height. The cylindrical package may be any cylindrical package described herein, e.g., may be cylindrical package 280.

The method 300a also comprises receiving (at 320) a user request to transport the consumer article.

In the first method 300a, the positioning (at 310) may be performed prior to the receiving (at 320) a user request to transport the consumer article. In other words, in the first method 300a, the consumer article may be positioned inside the cylindrical package before the consumer article has been ordered, purchased, sold, or otherwise authorized for transport. In second method 300b, the receiving (at 320) may be performed prior to the positioning (at 310). In other words, in the second method 300b, the consumer article may be positioned inside the cylindrical package in a “just in time” fashion, after the consumer article has been ordered, purchased, sold, or otherwise authorized for transport.

As should be apparent, the order of these steps as listed in the claims does not imply a temporal order of these steps, unless the claims explicitly specify a temporal order.

The method 300 further comprises securing (at 330) the cylindrical package into an apparatus comprising (i) a substantially horizontal member comprising a top surface, a front surface, a back surface, a right surface, and a left surface, wherein the front surface and the back surface are at opposite ends of the horizontal member, the right surface and the left surface are at the other opposite ends of the horizontal member, each pair of adjacent surfaces defines a corner, and the top surface substantially defines a horizontal plane; (ii) a right roller mount proximate the corner of the back surface and the right surface of the horizontal member; (iii) a left roller mount proximate the corner of the back surface and the left surface of the horizontal member; (iv) a roller having a right end rotatably coupled to the right roller mount and a left end rotatably coupled to the left roller mount; (v) a substantially vertical member comprising a front surface, a back surface, a bottom, a right surface, a left surface, and a top surface, wherein the bottom is integrated with or affixed to the horizontal member in proximity to the right roller mount and the left roller mount, and the front surface substantially defines a vertical plane; (vi) an upper strap mounted to the front surface of the vertical member closer to the top surface than to the bottom surface and at a distance from the horizontal member that is less than the first height, and comprising an upper fastener; and (vii) a lower strap mounted to the front surface of the vertical member closer to the bottom surface than to the top surface and comprising a lower fastener; wherein, during the securing, the horizontal member is positioned on a substantially horizontal surface such that the roller does not contact the substantially horizontal surface, and, after the securing, the upper strap provides a circle of about the first circumference when the upper fastener is fastened and the lower strap provides a circle of about the first circumference when the lower fastener is fastened.

The apparatus into which the cylindrical package is secured (at 330) may be any apparatus, e.g. apparatus 100, described above.

The method 300a also comprises elevating (at 340) the front surface of the horizontal member sufficiently above the substantially horizontal surface such that the roller contacts the substantially horizontal surface, such as a floor surface. Subsequently, the method 300a comprises transporting (at 350) the consumer article at least in part by rolling the roller along the substantially horizontal surface.

As should be apparent, other events may be performed between securing (at 330) and elevating (at 340), between elevating (at 340) and transporting (at 350), and/or between transporting (at 350) and (if performed as part of the method 300) removing (at 360, described below). Alternatively or in addition, transporting (at 340) may be performed more than once, with other events taking place between performance of the transporting (at 340). Such events may include moving the system comprising the cylindrical package and the apparatus other than by rolling on a substantially horizontal surface, e.g., lifting, such as by human muscle power, a powered lift, an escalator, an elevator, etc.; driving with the system positioned in a cargo compartment of a motor vehicle; or others that will be apparent to the person of ordinary skill in the art having the benefit of the present disclosure.

Transporting (at 350) and the other events may be performed by the user (e.g., the purchaser or the purchaser's delivery agent), an employee of the entity in initial possession of the consumer article, the cylindrical package, and/or the apparatus (e.g., an employee of a manufacturer, a wholesaler, a retailer, or a logistics provider serving one or more such entities).

In embodiments, the method 300a may, but need not, further comprise removing (at 360) the cylindrical package from the apparatus; and removing (at 370) the consumer article from the cylindrical package.

Removing (at 360) may comprise unfastening, in any appropriate manner, the fastener(s) of the upper strap and lower strap.

For removing (at 370) the consumer article from the cylindrical package, in embodiments, the cylindrical package may comprise a reversible closure selected from a zipper, one or more clasps, one or more snaps, one or more paired magnets, one or more cinches, one or more ratchets, or one or more pairs of hook-and-loop fabrics. The reversible closure may then be opened as appropriate (e.g., by unzipping, unclasping, unsnapping, manually separating paired magnets, or the like).

After removing (at 360) and removing (at 370), the user will have three components, namely, the consumer article, the cylindrical package, and the apparatus, but will generally only desire to have one component, the consumer article. Accordingly, the method 300 may further comprise returning (at 380) the apparatus, the cylindrical package, or both for reuse. The returning (at 370) may be performed by the same individual(s) performing the transporting (at 350) and related events, or by other individuals (e.g., apparatus and cylindrical package retrieval personnel, customer in-home purchase follow-up personnel, etc.).

The particular embodiments disclosed above are illustrative only, as the disclosure may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is, therefore, evident that the particular embodiments disclosed above may be altered or modified and all such variations are considered within the scope and spirit of the disclosure. Accordingly, the protection sought herein is as set forth in the claims below.

What is claimed is:

1. An apparatus, comprising:
a substantially horizontal member comprising a top surface, a front surface, a back surface, a right surface, and a left surface, wherein the front surface and the back surface are at opposite ends of the horizontal member, the right surface and the left surface are at the other opposite ends of the horizontal member, and the top surface substantially defines a support for receiving a package to be transported on the apparatus;
a right roller mount proximate the back surface and the right surface of the horizontal member;
a left roller mount proximate the back surface and the left surface of the horizontal member;
a roller having a right end rotatably coupled to the right roller mount and a left end rotatably coupled to the left roller mount, wherein, when the horizontal member is positioned on a floor surface, the roller does not support the horizontal member, and when the front surface of the horizontal member is sufficiently elevated above the floor surface, the roller contacts the floor surface and supports the horizontal member; and
a substantially vertical member comprising a front surface, a back surface, a bottom, a right surface, a left surface, and a top surface, wherein the bottom is integrated with or affixed to the horizontal member in proximity to the right roller mount and the left roller mount.

2. The apparatus of claim 1, further comprising:
an upper strap mounted to the front surface of the vertical member closer to the top surface than to the bottom surface of the vertical member; and
a lower strap mounted to the front surface of the vertical member closer to the bottom surface than to the top surface.

3. The apparatus of claim 2, wherein the upper strap and the lower strap each further comprise a fastener selected from a buckle, a snap, a button, paired magnets, complementary hook-and-loop fabric, a cinch, or a ratchet.

4. The apparatus of claim 3, wherein the upper strap and the lower strap are each configured to provide an opening of substantially similar shape and size when the fastener is closed to receive and retain a package having a cross section substantially similar to the shape and size of the opening.

5. The apparatus of claim 1, wherein the horizontal plane and the vertical plane are substantially orthogonal.

6. The apparatus of claim 1, wherein the vertical member further comprises an opening in proximity to the top surface, wherein the opening is sufficiently large to receive a 95^{th} percentile male hand.

7. The apparatus of claim 1, wherein the vertical member comprises a collapsible or retractable portion.

8. A system, comprising:
(a) an apparatus, comprising:
(i) a substantially horizontal member comprising a top surface, a front surface, a back surface, a right surface, and a left surface, wherein the front surface and the back surface are at opposite ends of the horizontal member, the right surface and the left surface are at the other opposite ends of the horizontal member, and the top surface substantially defines a support for receiving a package to be transported on the apparatus;
(ii) a right roller mount proximate the back surface and the right surface of the horizontal member;
(iii) a left roller mount proximate the back surface and the left surface of the horizontal member;
(iv) a roller having a right end rotatably coupled to the right roller mount and a left end rotatably coupled to the left roller mount, wherein, when the horizontal member is positioned on a floor surface, the roller does not support the substantially horizontal member, and when the front surface of the horizontal member is sufficiently elevated above the floor surface, the roller contacts the floor surface and supports the horizontal member; and
(v) a substantially vertical member comprising a front surface, a back surface, a bottom, a right surface, a left surface, and a top surface, wherein the bottom is integrated with or affixed to the horizontal member in proximity to the right roller mount and the left roller mount, and the front surface substantially defines a vertical plane;
(vi) an upper strap mounted to the front surface of the vertical member closer to the top surface than to the bottom surface and comprising an upper fastener, wherein the upper strap provides a circle of about a first circumference when the upper fastener is fastened; and
(vii) a lower strap mounted to the front surface of the vertical member closer to the bottom surface than to the top surface and comprising a lower fastener, wherein the lower strap provides a circle of about the first circumference when the lower fastener is fastened; and
(b) the package having a cross-sectional configuration of a substantially similar shape and size as the upper and lower straps and a height greater than the distance between the top surface of the horizontal member and the upper strap.

9. The system of claim 8, wherein the upper fastener and the lower fastener are each independently selected from a buckle, a snap, a button, paired magnets, complementary hook-and-loop fabric, a cinch, or a ratchet.

10. The system of claim 9, wherein the upper strap and the lower strap are substantially rigid.

11. The system of claim 8, wherein the vertical member further comprises an opening in proximity to the top surface, wherein the opening is sufficiently large to receive a 95^{th} percentile male hand.

12. The system of claim 11, wherein the opening is closer to the top surface of the vertical member than the upper strap is to the top surface of the vertical member.

13. The system of claim 8, wherein the package has a generally circular cross-section.

14. The system of claim 8, wherein the package has a generally rectangular cross-section.

15. The system of claim 8, wherein the package comprises an item located within a reversible closure selected from a zipper, one or more clasps, one or more snaps, one or more paired magnets, one or more cinches, one or more ratchets, or one or more pairs of hook-and-loop fabrics.

16. The system of claim 8, wherein the vertical member comprises a collapsible or retractable portion.

17. The system of claim 8, wherein the item is a mattress, a pillow, a sheet, a blanket, or a comforter conformed to be positioned inside the package.

18. A method, comprising:
positioning a consumer article selected from mattresses, pillows, sheets, blankets, or comforters inside a cylindrical package having a first circumference and a first height;
receiving a user request to transport the consumer article;
securing the cylindrical package into an apparatus comprising (i) a substantially horizontal member comprising a top surface, a front surface, a back surface, a right surface, and a left surface, wherein the front surface and the back surface are at opposite ends of the horizontal member, the right surface and the left surface are at the other opposite ends of the horizontal member, each pair of adjacent surfaces defines a corner, and the top surface substantially defines a horizontal plane; (ii) a right roller mount proximate the corner of the back surface and the right surface of the horizontal member; (iii) a left roller mount proximate the corner of the back surface and the left surface of the horizontal member; (iv) a roller having a right end rotatably coupled to the right roller mount and a left end rotatably coupled to the left roller mount; (v) a substantially vertical member comprising a front surface, a back surface, a bottom, a right surface, a left surface, and a top surface, wherein the bottom is integrated with or affixed to the horizontal member in proximity to the right roller mount and the left roller mount, and the front surface substantially defines a vertical plane; (vi) an upper strap mounted to the front surface of the vertical member closer to the top surface than to the bottom surface and at a distance from the horizontal member that is less than the first height, and comprising an upper fastener; and (vii) a lower strap mounted to the front surface of the vertical member closer to the bottom surface than to the top surface and comprising a lower fastener; wherein, during the securing, the horizontal member is positioned on a substantially horizontal surface such that the roller does not contact the substantially horizontal surface, and, after the securing, the upper strap provides a circle of about the first circumference when the upper fastener is fastened and the lower strap provides a circle of about the first circumference when the lower fastener is fastened;
elevating the front surface of the horizontal member sufficiently above the substantially horizontal surface such that the roller contacts the substantially horizontal surface; and
transporting the consumer article at least in part by rolling the roller along the substantially horizontal surface.

19. The method of claim 18, wherein the upper fastener and the lower fastener are each independently selected from a buckle, a snap, a button, paired magnets, complementary hook-and-loop fabric, a cinch, or a ratchet.

20. The method of claim 18, wherein the cylindrical package comprises a reversible closure selected from a zipper, one or more clasps, one or more snaps, one or more paired magnets, one or more cinches, one or more ratchets, or one or more pairs of hook-and-loop fabrics.

21. The method of claim 18, further comprising:
removing the cylindrical package from the apparatus; and
removing the consumer article from the cylindrical package.

22. The method of claim 21, further comprising:
returning the apparatus, the cylindrical package, or both for reuse.
